(19) United States
(12) Patent Application Publication
(10) Pub. No.: US 2010/0315564 A1
(43) Pub. Date: Dec. 16, 2010

(54) EMBEDDED ELECTRONIC DEVICE

(75) Inventors: LIANG-MAO HUNG, Tu-Cheng (TW); CHIH-YUAN CHUANG, Tu-Chen (TW); CHIA-HUNG CHIEN, Tu-Cheng (TW); JYH-GWO JU, Tu-Cheng (TW); TENG-YU TSAI, Tu-Cheng (TW); CHUN-WEN WANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/564,737

(22) Filed: Sep. 22, 2009

(30) Foreign Application Priority Data
Jun. 11, 2009 (CN) 200910303145.8

(51) Int. Cl. H04N 5/66

(52) U.S. Cl. 348/739

(57) ABSTRACT

An embedded electronic device includes a display, a foreground application module, and a plurality of standalone background function modules. The foreground application module is operable to display a plurality of accessible foreground applications on the display. The background function modules include a process handler module and a source manager library module. The process handler module is operable to switch between the plurality of accessible foreground applications. The process handler module is operable to destroy a running foreground application to launch a new foreground application. The source manager library module is operable to retrieve different kinds of multimedia resources to provide to the foreground application module.

### BACKGROUND

1. Technical Field

The present disclosure relates to an embedded electronic device, and particularly, to an embedded electronic device with rich content.

2. Description of Related Art

An embedded electronic device, such as a digital photo frame (DPF), for example, are becoming increasingly popular due to the convenience and ease of manipulation when implementing particular functions. However, the typical digital photo frame can only display the photos. The typical digital photo frame does not have more functions with rich content.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a construction view of an embedded electronic device.

FIG. 2 is a schematic view of an embedded electronic device.

FIG. 3 is a schematic view of a main menu of an embedded electronic device.

FIG. 4 is a schematic view of starting a foreground application of an embedded electronic device.

FIG. 5 is a schematic view of destroying the foreground application of an embedded electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

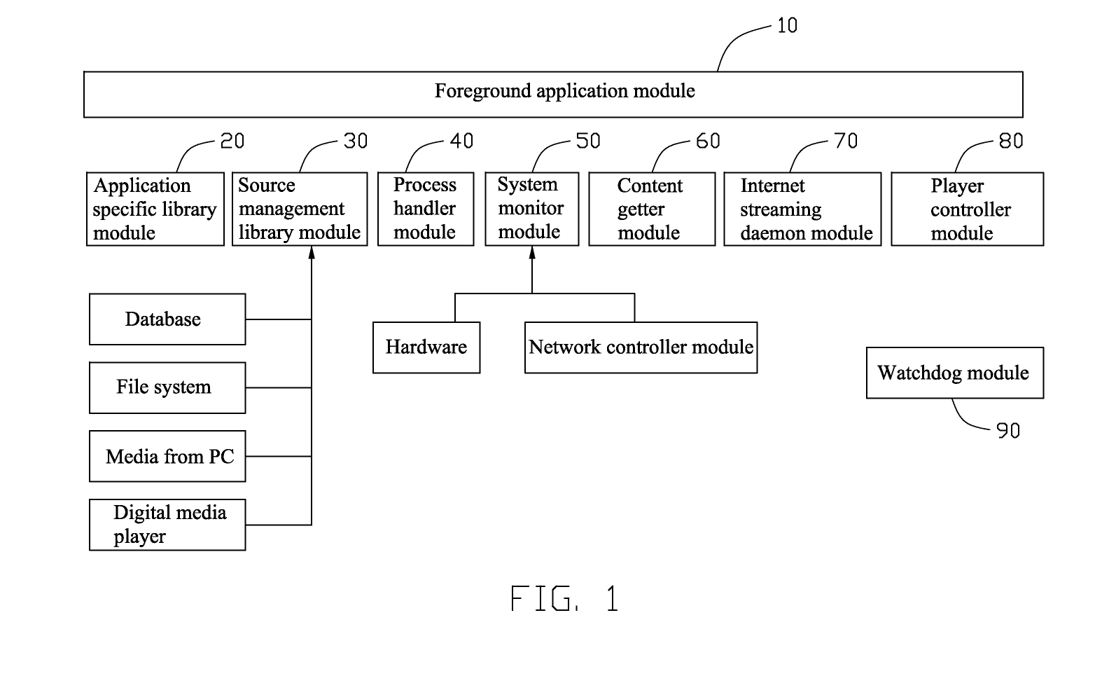

Referring to FIG. 1, an embedded electronic device 100 includes a foreground application module 10, an application specific library module 20, a source management library module 30, a process handler module 40, a system monitor module 50, a content getter module 60, an internet streaming daemon module 70, a player controller module 80, and a watchdog module 90. The foreground application module 10 includes a plurality of foreground applications. Each of the modules 10-90 is a standalone process so that if any one dies, the effect will be minimized.

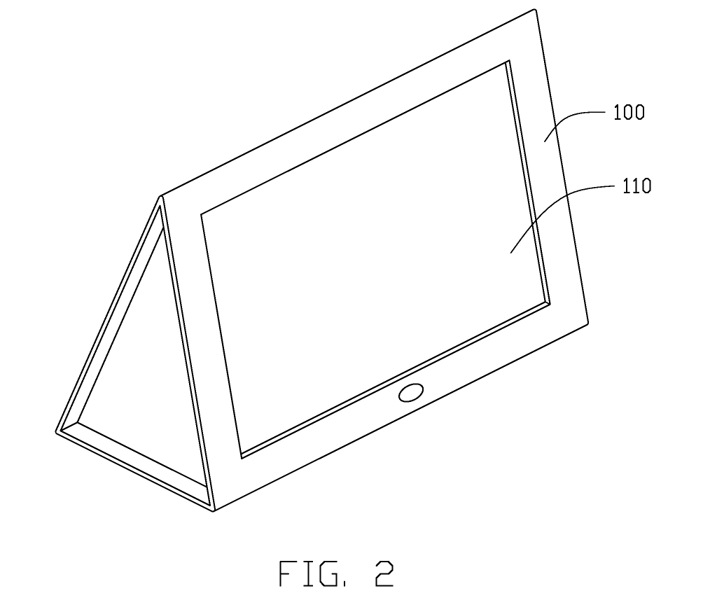

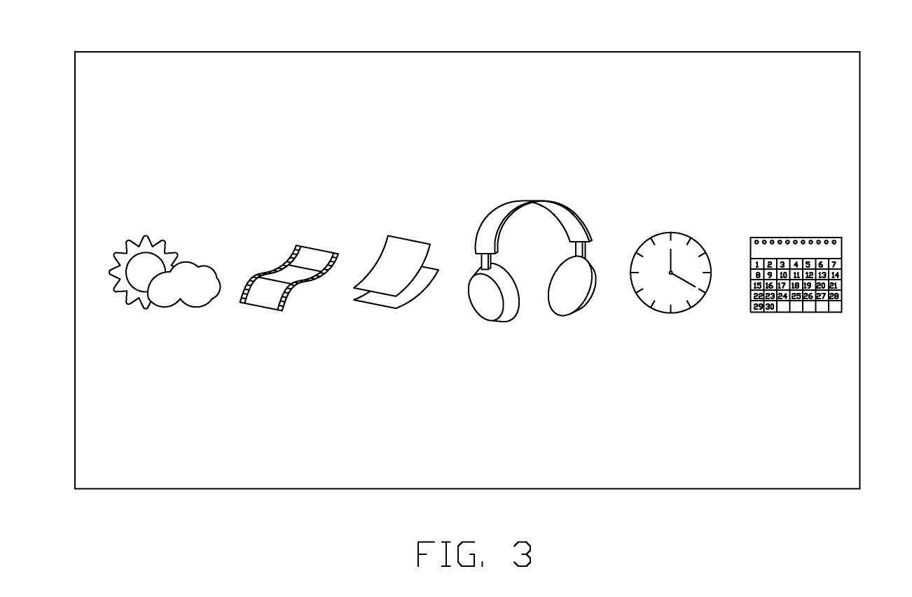

In one exemplary embodiment, and with reference to FIG. 2 and FIG. 3, the embedded electronic device 100 may be a digital photo frame. The embedded electronic device 100 includes a display 110 and a memory. One foreground application dominates the display 110 at a time. In FIG. 3, the display 110 shows a main menu. The main menu may include selections of weather, video, photo, music, calendar, and so on. The embedded electronic device 100 also includes a card reader, for example, a Secure Digital Memory (SD) card reader, a Compact Flash (CF) card reader, an Extreme Digital (XD) reader, but may also be connected to an external storage system.

The application specific library module 20 hides specific details of a foreground application, such as network protocols of HTTP. Thus, users do not need to know application details of the foreground application. Users can obtain what they want from the user interface. The source manager library module 30 is capable of retrieving different kinds of resources. The source manager library module 30 may, for example, retrieve resources from a database, a file system, a personal computer, and a digital media player and provide the resources to the foreground application module 10 to show.

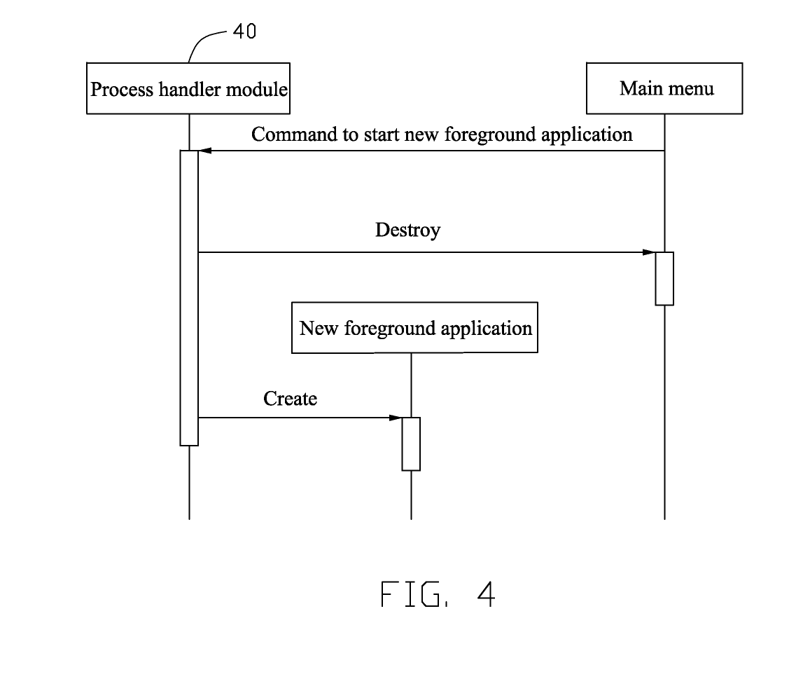

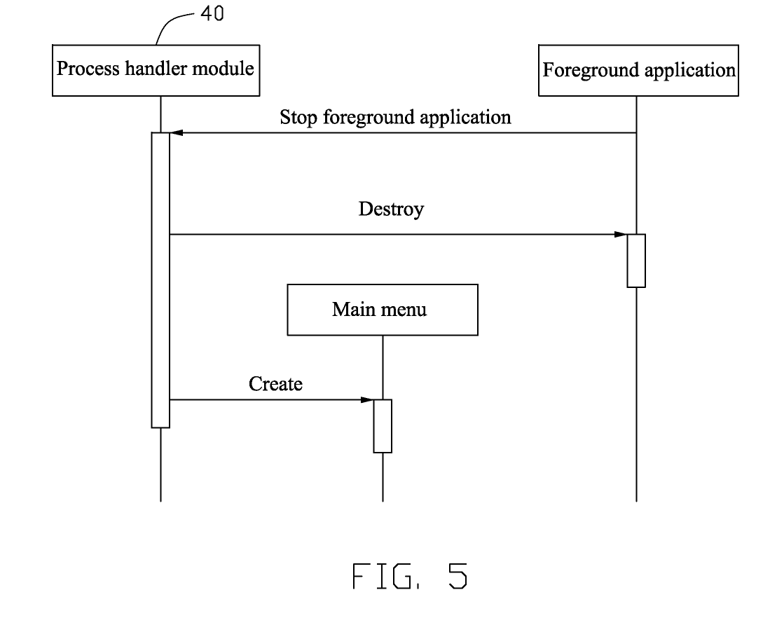

Referring to FIG. 4 and FIG. 5, the process handler module 40 is responsible for switching foreground applications, such as launching a foreground application from a main menu displayed on the display 110, returning to the main menu from the foreground application, and/or starting a screen saver or an alarm clock. The main menu of the embedded electronic device 100 sends a command to the process handler module 40 to start a new foreground application. The process handler module 40 removes the main menu from view of the display 110. Finally, the process handler module 40 launches the new foreground application on the embedded electronic device 100. In FIG. 4, when the foreground application is finished, the foreground application sends an application stop request to the process handler module 40. The process handler module 40 stops the foreground application. The process handler module 40 displays the main menu on the embedded electronic device 100.

The system monitor module 50 controls hardware devices, monitors hardware events, system resources, and bridge events between different foreground applications and user interfaces. For example, when a foreground application is running in the embedded electronic device 100 and when an alarm application module is started, the system monitor module 50 monitors a bridge event between the alarm application module (user interface) and the foreground application to start the alarm application module. The system monitor module 50 informs the foreground application to start the alarm application module. The foreground application sends a request to the process handler module 40 to shut down the foreground application module and start the alarm application module. The system monitor module 50 also obtains information from a network controller module. The network controller module configures network connections for the foreground application module, monitors network interface status, and monitors IP configuration status.

The content getter module 60 is responsible for obtaining Internet data for the foreground application module 10. The content getter module 60 allows data to be downloaded without blocking foreground operations. For example, if a video is playing on the embedded electronic device 100 the content getter module 60 can still download data from the Internet while the video is still being played.

The Internet streaming daemon module 70 manages the Internet streaming applications, such as to fetch next songs to be played. The player controller module 80 has an interface for a third party media player. The player controller module 80 provides a simple interface for application specific requirements, such as mute, adjust volume, load a song, load alarm file, etc. The watchdog module 90 restarts the main menu when the foreground application crashes accidentally to ensure the embedded electronic device 100 continues to run normally.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An embedded electronic device, comprising:
a display;
a foreground application module operable to display a plurality of accessible foreground applications of the embedded electronic device on the display;
a plurality of standalone background function modules, the background function modules comprising:
a process handler module operable to switch between the plurality of accessible foreground applications, the process handler module further operable to destroy a running foreground application to launch a new foreground application;
a source manager library module operable to retrieve access to different kinds of multimedia resources and provide the different kinds of multimedia resources to the foreground application module.

2. The embedded electronic device of claim 1, wherein the standalone background function modules further comprise a player controller module operable to provide an interface for the foreground application module for an application mute requirement.

3. The embedded electronic device of claim 1, wherein the standalone background function modules further comprise an internet streaming daemon module operable to control internet streaming applications of the embedded electronic device.

4. The embedded electronic device of claim 1, wherein the foreground application is a main menu, the standalone background function modules further comprise a watchdog module to restart the main menu when the foreground application module crashes.

5. The embedded electronic device of claim 1, wherein the standalone background function modules further comprise a content getter module to obtain Internet data and allow data to be downloaded without blocking foreground operations.

6. The embedded electronic device of claim 1, wherein the standalone background function modules further comprise a system monitor module operable to control hardware devices of the embedded electronic device and monitor hardware events.

7. The embedded electronic device of claim 1, wherein the standalone background function modules further comprise a network controller module to configure network connection and monitor network interface status of the embedded electronic device.

8. The embedded electronic device of claim 1, wherein the standalone background function modules further comprise an application specific library module operable to hide foreground application specific details from the display.

9. The embedded electronic device of claim 1, wherein the source manager library module comprises a database to provide data resources to the foreground application module.

10. The embedded electronic device of claim 1, wherein the source manager library module comprises a digital media player to provide media resources to the foreground application module.

11. An embedded electronic device, comprising:
a display;
a foreground application module operable to display a plurality of accessible foreground applications of the embedded electronic device on the display;
a plurality of standalone background function modules, the background function modules comprising:
a process handler module operable to switch between the plurality of accessible foreground applications, the process handler module further operable to destroy a running foreground application to launch a new foreground application;
a player controller module operable to provide an interface for the foreground application module for an application mute requirement.

12. The embedded electronic device of claim 11, wherein the standalone background function modules further comprise an application specific library module operable to hide foreground application specific details.

13. The embedded electronic device of claim 11, wherein the standalone background function modules further comprise an internet streaming daemon module operable to control for the internet streaming applications of the embedded electronic device.

14. The embedded electronic device of claim 11, wherein one foreground application is a main menu, the standalone background function modules further comprise a watchdog to restart the main menu when the foreground application module crashes.

15. The embedded electronic device of claim 11, wherein the standalone background function modules further comprise a content getter module to obtain Internet data and allow data to be downloaded without blocking foreground operations.

16. The embedded electronic device of claim 11, wherein the standalone background function modules further comprise a system monitor module operable to control hardware devices of the embedded electronic device and monitoring hardware events.

17. The embedded electronic device of claim 11, wherein the standalone background function modules further comprise a network controller module to configure network and monitor network interface status of the embedded electronic device.

18. The embedded electronic device of claim 11, wherein the standalone background function modules further comprise a source manager library module operable to retrieve access to different kinds of multimedia resources and provide the different kinds of multimedia resources to the foreground application module.

19. The embedded electronic device of claim 18, wherein the source manager library module comprises a database to provide data resources to the foreground application module.

20. The embedded electronic device of claim 18, wherein the source manager library module comprises a digital media player to provide media resources to the foreground application module.
